(19) United States
(12) Patent Application Publication
(10) Pub. No.: US 2013/0145256 A1
(43) Pub. Date: Jun. 6, 2013

(54) CONTEXT-DEPENDENT SYLING FOR DOCUMENTS

(71) Applicants: Anil Kumar Padala, Flower Mound, TX (US); Manah Khalil, Irving, TX (US); Somesh Sharma, Flower Mound, TX (US)

(72) Inventors: Anil Kumar Padala, Flower Mound, TX (US); Manah Khalil, Irving, TX (US); Somesh Sharma, Flower Mound, TX (US)

(73) Assignee: VERIZON PATENT AND LICENSING INC., Basking Ridge, NJ (US)

(21) Appl. No.: 13/310,102

(22) Filed: Dec. 2, 2011

(51) Int. Cl. G06F 17/00

(52) U.S. Cl. 715/235

(57) ABSTRACT

A method, performed by a computer device, may include retrieving a document and determining context information associated with the document. The method may further include identifying an element in the document, where the element includes a context-dependent style specification; determining whether a context associated with the context-dependent style specification matches the determined context information; and applying a style associated with the context-dependent style specification to the element, when the context associated with the context-dependent style specification matches the determined context specification.

### BACKGROUND INFORMATION

A document may include a significant amount of information and may be used for multiple purposes. A first set of elements in the document may be determined to be important with respect to a first purpose and a second set of elements in the document may be determined to be important with respect to a second purpose. For example, a customer representative may pull up a document that includes information about a customer when the customer calls with a problem. The customer may need to authenticate the customer by verifying information such as account number and password. As the document may include a significant amount of information about the customer, the customer representative may find it difficult to quickly locate the required information in the document. After authentication, the customer representative may need to locate other information on the same document for another purpose. While different versions of the document may be maintained, each version including information required for a particular purpose, such a solution may be inefficient.

### BRIEF DESCRIPTION OF THE DRAWINGS

FIG. 1 is a diagram illustrating an exemplary environment according to an implementation described herein;

FIG. 2 is a diagram illustrating exemplary components of a device of FIG. 1;

FIG. 3 is a diagram illustrating exemplary functional components of the document styling system of FIG. 1;

FIG. 4 is a diagram illustrating exemplary components of a document file according to an implementation described herein;

FIG. 5 is a flow chart of an exemplary process for generating context-dependent styling for a document according to an implementation described herein;

FIG. 6 is a flow chart of an exemplary process for providing a document that includes context-dependent styling according to an implementation described herein;

FIG. 7 is a flow chart of an exemplary process for applying styling to an element of a document according to an implementation described herein;

FIGS. 8A-8C are diagrams of a first example of generating and providing a document with context-dependent styling according to an implementation described herein;

FIGS. 9A-9C are diagrams of a second example of generating and providing a document with context-dependent styling according to an implementation described herein; and

FIGS. 10A-10C are diagrams of a third example of generating and providing a document with context-dependent styling according to an implementation described herein.

### DETAILED DESCRIPTION OF PREFERRED EMBODIMENTS

The following detailed description refers to the accompanying drawings. The same reference numbers in different drawings identify the same or similar elements.

An implementation described herein may relate to context-dependent styling of elements in a document. An element in a document may include a styling expression that includes a style definition expression and a style activation expression. The style definition expression may define a particular style for the element and the style activation expression may define a particular condition that, if satisfied, causes the particular style to be applied to the element. The document may include a reference to a set of instructions (e.g., a script file) that applies the particular style to the element by processing the style definition expression. Moreover, the document may include a reference to a set of instructions (e.g., a script file) that determines values for one or more variables associated with the particular condition. For example, the particular condition may be met if one of the variables corresponds to a particular value.

A document, as the term is used herein, is to be broadly interpreted to include any machine-readable and machine-storable work product. A document may include, for example, an e-mail, a web page or a web site, a file, a combination of files, one or more files with embedded links to other files, a news group posting, a news article, a blog, a business listing, an electronic version of printed text, a web advertisement, etc. In the context of the web (i.e., the Internet), a common document may be a web page. Documents often include textual information and may include embedded information (such as meta information, images, hyperlinks, etc.) and/or embedded instructions (such as Javascript, etc.).

A document element may include any part of a document included within a tag, such a Hypertext Markup Language (HTML) tag or an Extensible Markup Language (XML) tag. A tag may enclose, for example, text, such as a label, heading, paragraph, anchor text of a hyperlink, and/or another type of text; an input element such as a text box, a button, a radio button, a menu, a slider, a scroll bar, and/or another type of input element; an image, video, graphic, icon, and/or another type of graphical element; a tag defining a document property, such as background color, default text style, and/or another type of document property; and/or any other document element that may be enclosed by a tag.

A style specification may express how a particular element, or a particular attribute, of a document is presented to a user. For example, a style specification may define a font, text size, color, layout, text effect, highlighting, lowlighting, whether an element should be displayed, and/or another attribute by relating the attribute to a particular value. In one embodiment, the style may be specified in a style sheet language, such as, for example, the Cascading Style Sheets language. In another embodiment, the style may be specified using another technique.

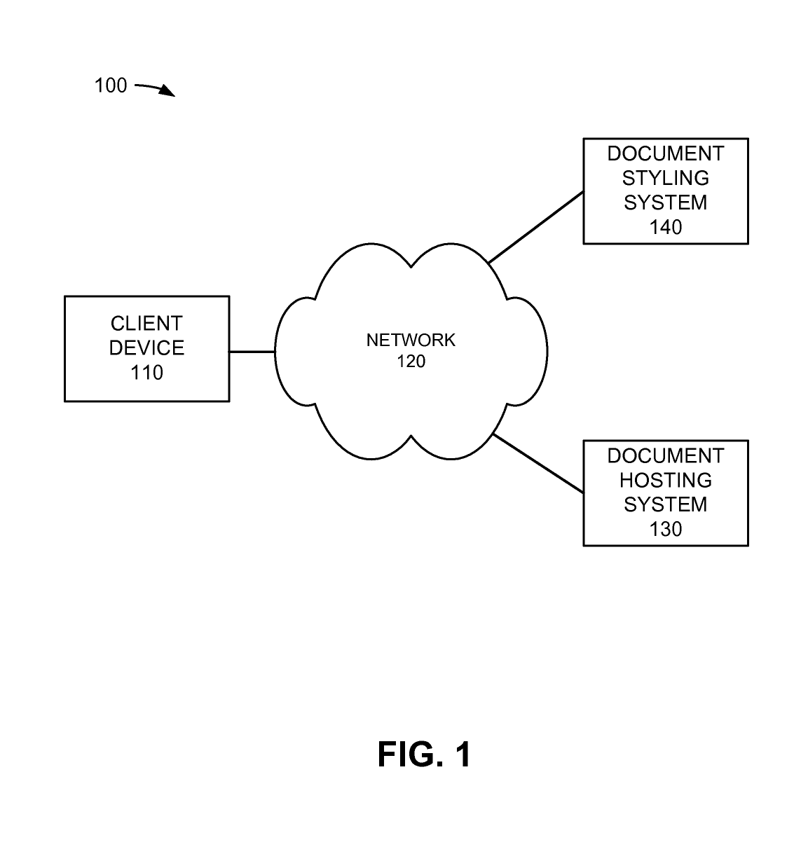

FIG. 1 is a diagram of an exemplary environment 100 in which the systems and/or methods described herein may be implemented. As shown in FIG. 1, environment 100 may include a client device 110, a network 120, a document hosting system 130, and a document styling system 140. While FIG. 1 depicts a single client device 110, a single document hosting system 130, and a single document styling system 140 for illustrative purposes, in practice, environment 100 may include multiple client devices 110, multiple document hosting systems 130, and/or multiple document styling systems 140.

Client device 110 may include any device capable of accessing a document across a network using, for example, a browser application (e.g., Internet Explorer, Mozilla Firefox, Google Chrome, Apple Safari, Opera, etc.). Client device 110 may access a document hosted by document hosting system 130. Client device 110 may include a desktop computer; a laptop computer; a tablet computer; a mobile communication device, such as a mobile phone, a smart phone, a tablet computer, a laptop, a personal digital assistant (PDA), or another type of portable communication device; and/or another type of computation and/or communication device.

Network 120 may enable client device 110, document hosting system 130, and document styling system 140 to communicate with each other. Network 120 may include one or more wired and/or wireless networks. For example, network 120 may include a cellular network, the Public Land Mobile Network (PLMN), a second generation (2G) network, a third generation (3G) network, a fourth generation (4G) network (e.g., a long term evolution (LTE) network), a fifth generation (5G) network, a code division multiple access (CDMA) network, a global system for mobile communications (GSM) network, a general packet radio services (GPRS) network, a combination of the above networks, and/or another type of wireless network. Additionally, or alternatively, network 120 may include a local area network (LAN), a wide area network (WAN), a metropolitan area network (MAN), an ad hoc network, an intranet, the Internet, a fiber optic-based network (e.g., a fiber optic service network), a satellite network, a television network, and/or a combination of these or other types of networks.

Document hosting system 130 may include one or more computing devices, such as server devices, that host documents. For example, document hosting system 130 may include a server device that stores a document that includes one or more interactive elements. The document may be accessed by a user of client device 110 using a browser application, provided to client device 110, and displayed by client device 110 to the user. The user may provide input in connection with an interactive element in the document (e.g., by entering text into a text box) and client device 110 may send information associated with the input to document hosting system 130. Document hosting system 130 may store the received information and associate the received information with the interactive element and with client device 110.

Document styling system 140 may include one or more computing devices, such as server devices, that create and/or modify a document, hosted by document hosting system 130, to include one or more elements with context-dependent styling. For example, document hosting system 130 may provide an interface that allows a user to select a document, determine context specifications for the document, identify elements in the document that are associated with the determined context specifications, and select styling specifications for the identified elements. Document styling system 140 may modify the selected document to include context-dependent styling for the identified elements in the document, based on the determined context specifications and based on the selected styling specifications.

Although FIG. 1 shows exemplary components of environment 100, in other implementations, environment 100 may include fewer components, different components, differently arranged components, or additional components than depicted in FIG. 1. Additionally or alternatively, one or more components of environment 100 may perform functions described as being performed by one or more other components of environment 100.

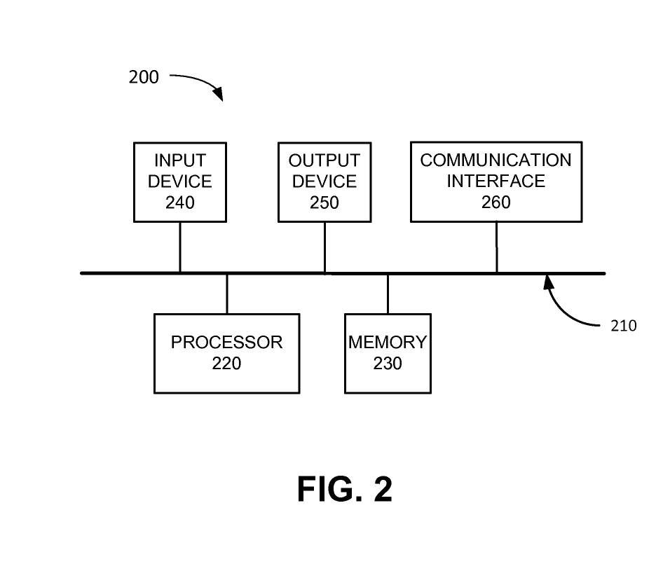

FIG. 2 is a diagram illustrating exemplary components of a device 200 according to an implementation described herein. Client device 110, document hosting system 130, and/or document styling system 140 may each include one or more devices 200. As shown in FIG. 2, device 200 may include a bus 210, a processor 220, a memory 230, an input device 240, an output device 250, and a communication interface 260.

Bus 210 may include a path that permits communication among the components of device 200. Processor 220 may include any type of single-core processor, multi-core processor, microprocessor, latch-based processor, and/or processing logic (or families of processors, microprocessors, and/or processing logics) that interprets and executes instructions. In other embodiments, processor 220 may include an application-specific integrated circuit (ASIC), a field-programmable gate array (FPGA), and/or another type of integrated circuit or processing logic.

Memory 230 may include any type of dynamic storage device that may store information and/or instructions, for execution by processor 220, and/or any type of non-volatile storage device that may store information for use by processor 220. For example, memory 230 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 240 may allow an operator to input information into device 200. Input device 240 may include, for example, a keyboard, a mouse, a pen, a microphone, a remote control, an audio capture device, an image and/or video capture device, a touch-screen display, and/or another type of input device. In some embodiments, device 200 may be managed remotely and may not include input device 240. In other words, device 200 may be “headless” and may not include a keyboard, for example.

Output device 250 may output information to an operator of device 200. Output device 250 may include a display, a printer, a speaker, and/or another type of output device. For example, device 200 may include a display, which may include a liquid-crystal display (LCD) for displaying content to the customer. In some embodiments, device 200 may be managed remotely and may not include output device 250. In other words, device 200 may be “headless” and may not include a display, for example.

Communication interface 260 may include a transceiver that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 260 may include a transmitter that converts baseband signals to radio frequency (RF) signals and/or a receiver that converts RF signals to baseband signals. Communication interface 260 may be coupled to an antenna for transmitting and receiving RF signals.

Communication interface 260 may include a logical component that includes input and/or output ports, input and/or output systems, and/or other input and output components that facilitate the transmission of data to other devices. For example, communication interface 260 may include a network interface card (e.g., Ethernet card) for wired communications and/or a wireless network interface (e.g., a WiFi) card for wireless communications. Communication interface 260 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 200 may perform certain operations relating to context-dependent styling of elements in a document. Device 200 may perform these operations in response to processor 220 executing software instructions contained in a computer-readable medium, such as memory 230. A computer-readable medium may be defined as a non-transitory memory device. A memory device may be implemented within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of, or in combination with, software instructions to implement processes described herein. Thus, implementations described herein are not limited to any specific combination of hardware circuitry and software.

Although FIG. 2 shows exemplary components of device 200, in other implementations, device 200 may include fewer components, different components, additional components, or differently arranged components than depicted in FIG. 2. Additionally or alternatively, one or more components of device 200 may perform one or more tasks described as being performed by one or more other components of device 200.

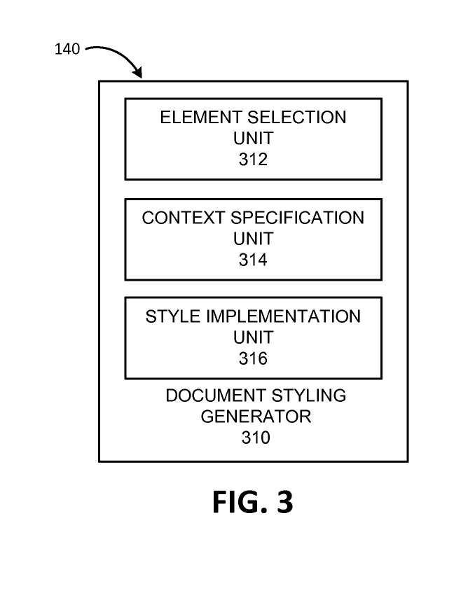

FIG. 3 is a diagram of exemplary functional components of document styling system 140. The functional components of document styling system 140 may be implemented, for example, via processor 220 executing instructions from memory 230. As shown in FIG. 3, document styling system 140 may include a document styling generator 310. Document styling generator 310 may provide a user interface that enables a user to select an element in a document, select a particular style for the element, and select a particular condition that triggers the particular style to be applied to the element. Document styling generator 310 may include an element selection unit 312, a context specification unit 314, and a style implementation unit 316.

Element selection unit 312 may enable the user to select an element or to select, a particular category of document elements, and/or a document attribute (e.g., background color) of a document.

Context specification unit 314 may enable the user to select a context specification for a selected element. For example, the user may select a variable and a particular value or range of values for the variable. Context specification unit 314 may add a set of instructions, such as a script file, to determine a value for the variable. The value for the variable may be stored remotely to the document and the script file may retrieve the value for the variable from a remote location. For example, the variable may correspond to a type of user accessing the document. The type of user may be determined by another document and stored with connection with the other document. Context specification unit 314 may generate a script file that retrieves the value of the variable, associated with the type of user, from the other document.

Style implementation unit 316 may enable a user to specify a particular style for the particular element and covert the particular style, specified by the user, into a particular format (e.g., into a style language expression). For example, the user may be provided with an interface that allows the user to select a style from a set of menus or radio buttons that enable the user to select a color, font, text style, etc. and the user's selections may be converted into a style language expression.

Although FIG. 3 shows exemplary functional components of document styling system 140, in other implementations, document styling system 140 may include fewer functional components, different functional components, differently arranged functional components, or additional functional components than depicted in FIG. 3A. Additionally or alternatively, one or more functional components of document styling system 140 may perform functions described as being performed by one or more other functional components of document styling system 140.

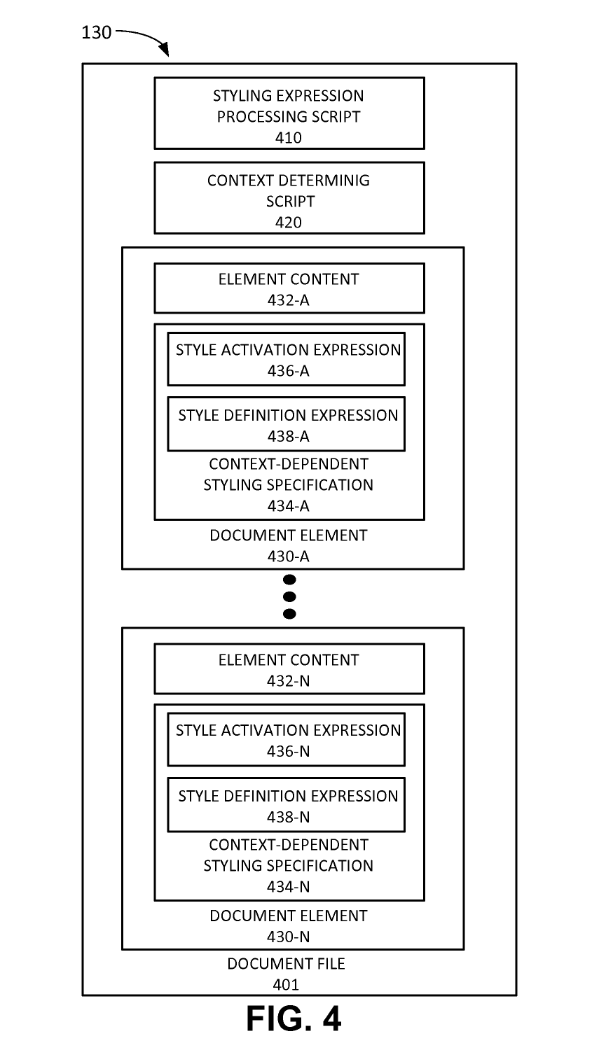

FIG. 4 is a diagram of an exemplary document file 401 that may be hosted by document hosting system 130 and that may have been modified by document styling system 140 to include elements with context-dependent styling. As shown in FIG. 4, document file 410 may include a styling expression processing script 410, a context determining script 420, and one or more document elements 430-A to 430-N (referred to herein collectively as “document elements 430” and individually as “document element 430”). While a single document file 401 is depicted in FIG. 4 for illustrative purposes, document hosting system 130 may include multiple document files 401.

Styling expression processing script 410 may include a script, or reference an external script, that processes a context-dependent styling specification, associated with document element 430, and determines whether a particular condition, associated with the context-dependent styling specification, is satisfied. If the particular condition is satisfied, styling expression processing script 410 may process a style definition expression included in the context-dependent styling specification and may apply a particular style to the element based on the style definition expression. In one implementation, styling expression processing script 410 may include a Javascript. Additionally or alternatively, styling expression processing script 410 may reference a jQuery library. In another implementation, styling expression processing script 410 may include a different type of script.

Context determining script 420 may include a script, or reference an external script, that determines a particular context for document file 401. For example, context determining script 420 may determine a value for a particular variable. In one implementation, context determining script 420 may include instructions to retrieve the value from a particular data structure. In another implementation, context determining script 420 may include instructions to prompt the user accessing the document to enter the value. In yet another implementation, context determining script 420 may determine the value using another technique. In one implementation, context determining script 420 may include a Javascript. In another implementation, context determining script 420 may include a different type of script.

Each document element 430 may include an element of document file 401 enclosed by a set of tags (e.g., HTML tags, XML tags, etc.). Document element 430 may include element content 432 and a context-dependent styling specification 434. Element content 432 may include the content of the document element (e.g., text, link, image, video, a storage location for content that is to be retrieved, etc.). Context-dependent styling specification 434 may specify a particular style that is to be applied to the document when a particular condition is met. Context-dependent styling specification 434 may include a style activation expression 436 and a style definition expression 438.

Style activation expression 436 may specify a particular condition that must be satisfied in order for the style defined by style definition expression 438 to be applied to document element 430. Style definition expression 438 may define a particular style that is to be applied to document element 430. For example, if document file 401 corresponds to a document used by a customer representative to process a customer call, style activation expression 436 may indicate that the style is to be applied if a call type variable corresponds to a billing topic and style definition expression 438 may specify a yellow background for document element 430. Thus, in this example, if the call type corresponds to a billing topic, document element 430 may be highlighted.

Although FIG. 4 shows exemplary fields that may be included in document file 401, in other implementations, document file 401 may include fewer fields, different fields, differently arranged fields, and/or additional fields than depicted in FIG. 4.

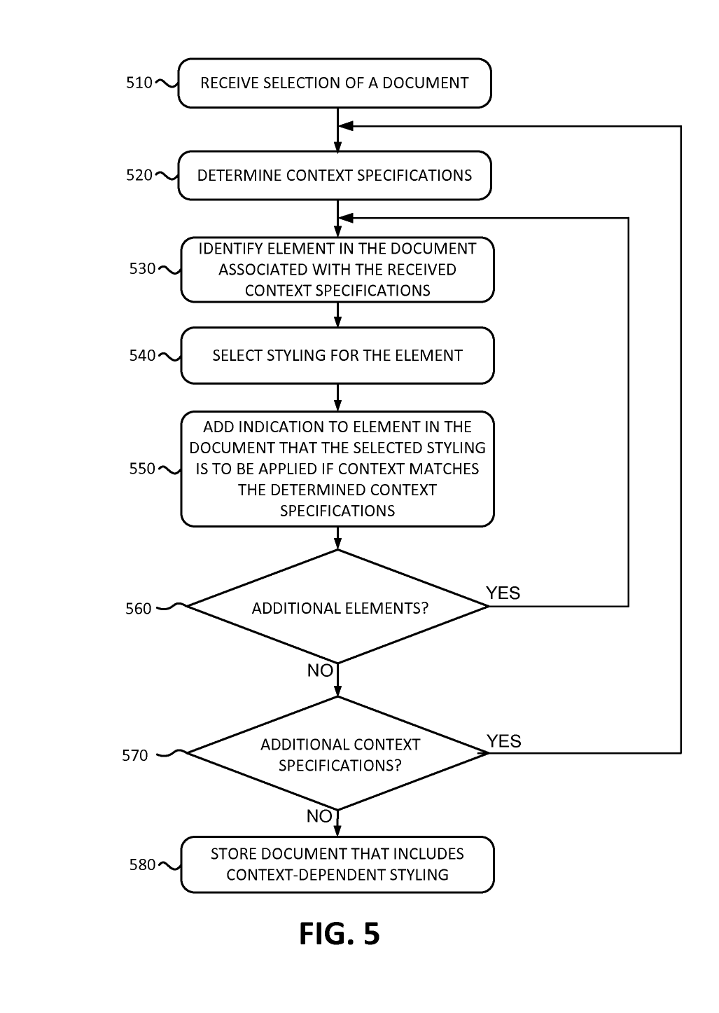

FIG. 5 is a flow chart of an exemplary process for generating context-dependent styling for a document according to an implementation described herein. In one implementation, the process of FIG. 5 may be performed by document styling system 140. In other implementations, some or all of the process of FIG. 5 may be performed by another device or a group of devices separate from document styling system 140 and/or including document styling system 140.

The process of FIG. 5 may include receiving a selection of a document (block 510). For example, a user may activate document styling generator 310 of document styling system 140 and document styling generator 310 may present a user interface to the user, prompting the user to select a document to modify to include context-dependent styling. The user may select a document hosted by document hosting system 130.

Context specifications may be determined (block 520). For example, context specification unit 314 of document styling generator 310 may prompt the user to enter context specifications for the selected document. In one implementation, the user may enter text and document styling generator 310 may search document hosting system 130 for documents and/or data structures that include a variable (e.g., an element associated with an input type) that matches the entered text. For example, the user may type in “user type” and document styling generator 310 may identify a data structure that stores a user type. In another implementation, the user may enter an address of a storage location (e.g., a Uniform Resource Identifier) of a variable. In yet another implementation, a user may be provided with a list of variables and may select a particular variable from the list. In yet another implementation, the user may indicate that the context specifications may be determined dynamically when a document is accessed. For example, the user may indicate that the context specifications may depend on user input in connection with a particular element 430 of document file 401.

After selecting a variable, the user may be prompted to select a value or a set of values for the variable. For example, if the variable corresponds to a user type, the user may select “customer representative” as the value for the variable. Document styling generator 310 may generate style activation expression 436 based on the received user input. For example, if the user selected user type as the variable and “customer representative” as the value for the variable, the generated style activation expression 436 may correspond to ‘style_on=‘user_type=customer_representative.’”

An element in the document associated with the determined context specifications may be identified (block 530). For example, element selection unit 312 of document styling generator 310 may display elements of the document and may prompt the user to select an element of the document. As another example, the user may enter an identifier associated with an element of the document.

Styling for the element may be selected (block 540). For example, style implementation unit 316 of document styling generator 310 may prompt the user to enter a particular style for the selected element. In one example, the user may enter text specifying the particular style. In another example, the user may be provided with a set of style options and may select one or more of the options. For example, the user may select that the styling for the element should include yellow highlighting. Document styling generator 310 may convert the user selection of the particular style into an expression in a style language (e.g., CSS) and may generate a style definition expression 438 that includes the expression in the style language. For example, if the user selected yellow highlighting, the generated style definition expression 438 may correspond to ‘style_def=‘color: #FFFF00; background-color: #FF0000.’”

An indication may be added to the element in the document that the selected styling is to be applied if context matches the determined context specifications (block 550). For example, document styling generator 310 may add style activation expression 436 and style definition expression 438 to document element 430.

A determination may be made about whether there are additional elements to be processed (block 560). For example, element selection unit 312 of document styling generator 310 may prompt to user to select another element or to indicate that element selection has been completed. If it is determined that there are additional elements to be processed (block 560—YES), processing may return to block 530 to identify another element associated with the determined context specifications.

If it is determined that there are no additional elements to be processed (block 560—NO), a determination may be made as to whether there are additional context specifications to be processed (block 570). For example, context specification unit 314 of document styling generator 310 may prompt the user to indicate whether additional context specifications are to be processed for the document. If it is determined that there are additional context specifications (block 570—YES), processing may return to block 520 to determine another set of context specifications. If it is determined that there are no additional context specifications (block 570—NO), the document that includes context-dependent styling may be stored (block 580). For example, document styling generator 310 may store the modified document in document hosting system 130.

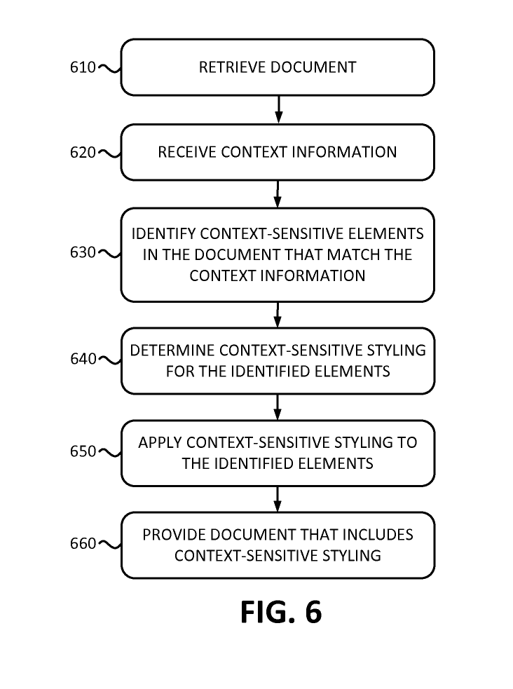

FIG. 6 is a flow chart of an exemplary process for providing a document that includes context-dependent styling according to an implementation described herein. In one implementation, the process of FIG. 6 may be performed by client device 110. In other implementations, some or all of the process of FIG. 6 may be performed by another device or a group of devices separate from client device 110 and/or including client device 110.

The process of FIG. 6 may include retrieving a document (block 610). For example, a browser application running on client device 110 may access document file 401, hosted by document hosting system 130. Context information may be received (block 620). For example, when the browser application retrieves document file 401, the browser application may run context determining script 420. Context determining script 420 may cause the browser application to determine values for one or more variables specified by the browser application.

Context-sensitive elements in the document that match the context information may be identified (block 630). For example, when the browser application retrieves document file 401, the browser application may run styling expression processing script 410. Styling expression processing script 410 may cause the browser application to identify document elements 430 that include style activation expressions 436.

Context-sensitive styling for the identified elements may be determined (block 640). For example, styling expression processing script 410 may cause the browser application to determine whether each of the identified document elements 430 includes a style activation expression 436 that matches the determined context information. If the style activation expression 436 matches the determined context information, styling expression processing script 410 may cause the browser application to determine context-sensitive styling for each of the identified document elements by analyzing style definition expressions 438 associated with each of the identified document elements 430.

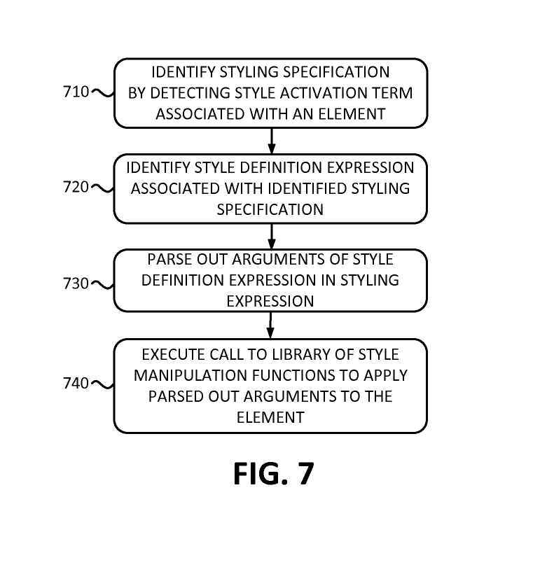

Context-sensitive styling may be applied to the identified elements (block 650). For example, styling expression processing script 410 may cause the browser application to apply the context-sensitive styling, specified by style definition expression 438, to document element 430. An exemplary process for applying context-sensitive styling to document element 430 is described below with reference to FIG. 7. A document that includes context-sensitive styling may be provided to the user (block 660). For example, the browser application may render the document to output device 250 of client device 110.

FIG. 7 is a flow chart of an exemplary process for applying styling to an element of a document according to an implementation described herein. In one implementation, the process of FIG. 7 may be performed by client device 110. In other implementations, some or all of the process of FIG. 7 may be performed by another device or a group of devices separate from client device 110 and/or including client device 110.

The process of FIG. 7 may include identifying a styling specification by detecting a style activation term associated with an element (block 710). For example, styling expression processing script 410 may cause a browser application, upon accessing document file 401, to identify style activation expression 436 that includes a style activating term. For example, the style activating term may correspond to the term “highlighton” and the browser application may identify document element 430 that includes a “highlighton” term.

A style definition expression associated with the identified styling specification may be identified (block 720). For example, styling expression processing script 410 may cause the browser application to identify style definition expression 438 by identifying a style definition term included in styling expression processing script 410. For example, the style definition term may correspond to the term “highlightstyle” and the browser application may identify the style definition expression 438 by locating the term “highlightstyle” in document element 430.

Arguments of a style definition expression may be parsed out in a styling expression (block 730). For example, styling expression processing script 410 may parse out arguments of style definition expression 438 based on one or more delimiting characters identified in styling expression processing script 410. For example, if style definition expression 438 corresponds to ‘highlightstyle=“color: #FFFF00; background-color: #FF0000,” styling expression processing script 410 may parse out a first argument “color” with a value of “FFF00” and a second argument “background-color” with a value of “FF0000.”

A call to a library of style manipulation functions may be executed to apply the parsed out arguments to the element (block 740). For example, styling expression processing script 410 may call a style manipulation function to apply each of the arguments to the element. In one implementation, the library of style manipulation functions may include a jQuery library. For example, if the parsed out arguments for an element with an identifier of “first_element” include a first argument “color” with a value of “FFF00” and a second argument “background-color” with a value of “FF0000,” and if the style manipulation function corresponds to a jQuery library function, styling expression processing script 410 may execute a first function call corresponding to “$(first_element).css(‘color’, ‘FFFF00’)” and a second function call corresponding to “$(first_element).css(‘background-color’, ‘FFF00))’).”

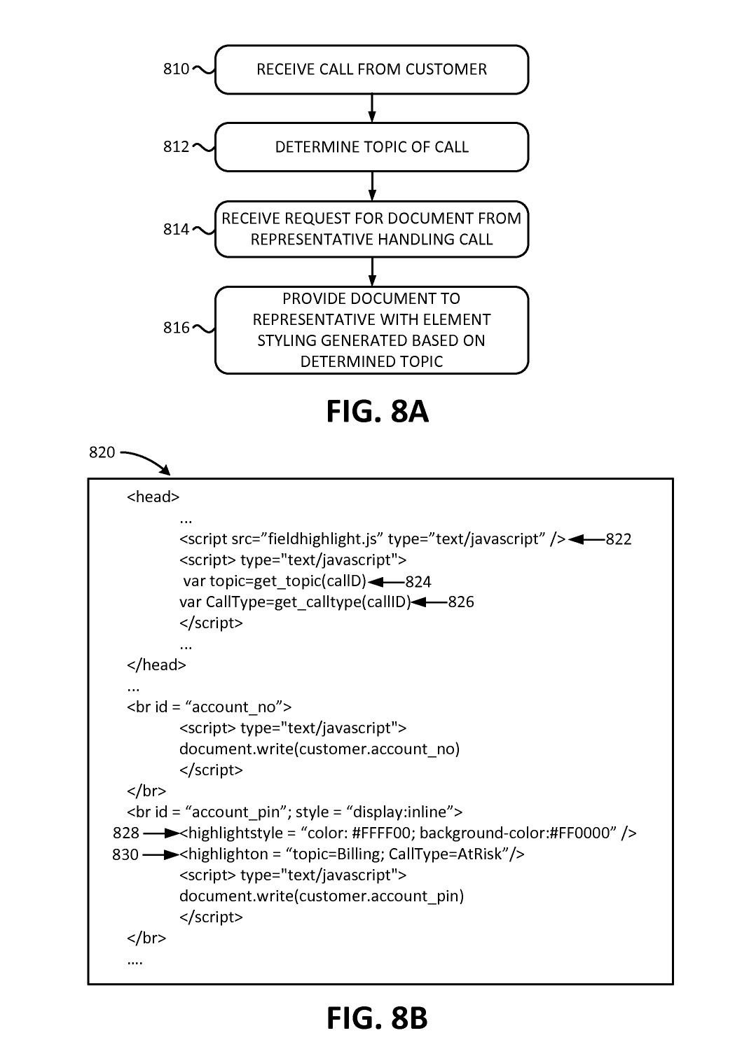

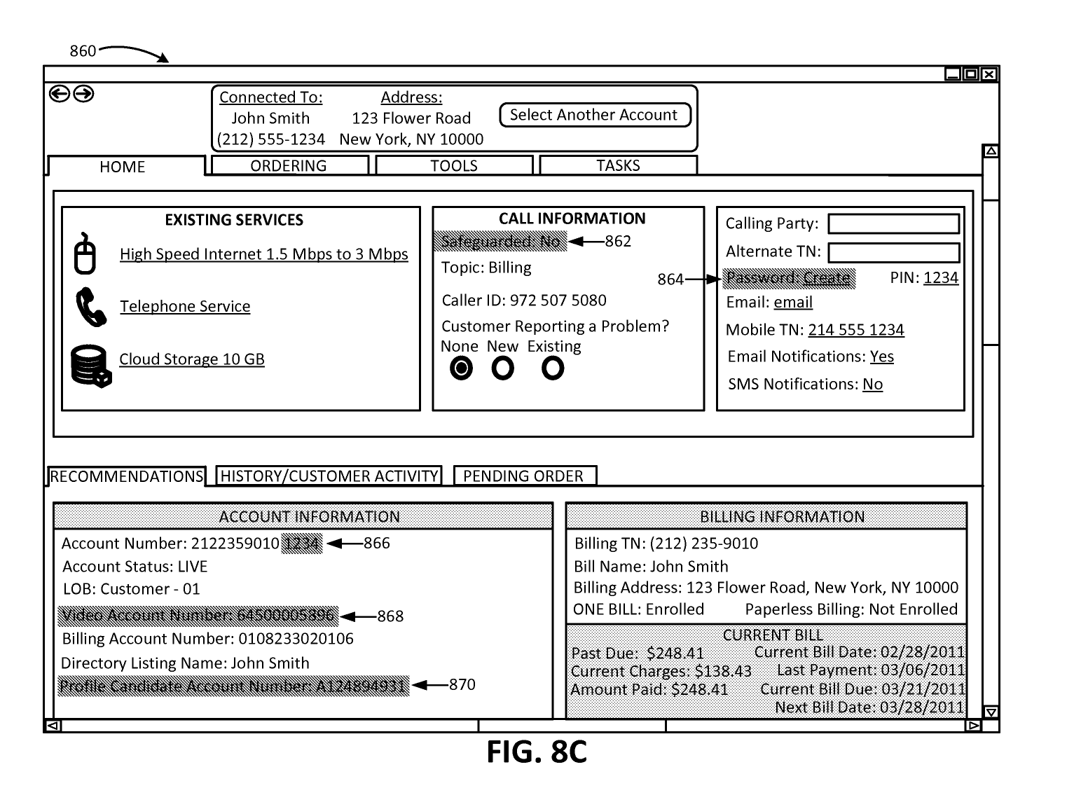

FIGS. 8A-8C are diagrams of a first example of generating and providing a document with context-dependent styling according to an implementation described herein. The example of FIGS. 8A-8C illustrates an example where particular fields of a document, used by a customer representative to process a call from a customer, are highlighted if the call is classified into a billing call or a customer complaint call.

FIG. 8A illustrated a process for providing a document to a customer representative. A call may be received from a customer (810) and a topic for the call may be determined (block 812). For example, a call may be received by a call center and a new document (e.g., a new service ticket) may be generated by document hosting system 130 for the call. A call topic may be indicated on the generated document. As another example, the customer may select a call topic from an automated voice menu by pushing a button on the customer's telephone and the customer's selection may be stored in a particular location by document hosting system 130.

The call may be forwarded to a customer representative and the customer representative may open the document to process the call (block 814). The document may be provided to the customer representative with element styling generated based on the determined topic (block 816).

FIG. 8B illustrates a document portion 820 of the document provided to the customer representative. Document portion 820 may include a reference to a fieldhighlight script 822 (which may correspond to styling expression processing script 410) and may include a topic determining function 826 (which may correspond to context determining script 420). Topic determining function 826 may determine a topic for the call by retrieving a value for a call topic variable by accessing an external data structure reference by a call identifier. The call identifier may be generated when the call is received and may be passed on to the document when the document is accessed by the customer representative. Fieldhighlight script 822 may process elements of the document to identify elements that include a style activation term, which, in this case, may correspond to the term “highlighton.”

A document element with an identifier of “account_pin” may include highlight activation expression 828 and highlight definition expression 830. Highlight activation expression 828 may indicate that if the call topic corresponds to a “billing” topic or to a “customer complaint” topic, or if a call type variable corresponds to an “at_risk” type, then highlighting should be turned on for the “account_pin” element. Highlight definition expression 830 may indicate that the highlight style that is to be applied includes yellow text (#FFFF00) with a red background (#FF0000).

FIG. 8C illustrates an example document 860 that may be provided by document hosting system 130 to client device 110 operated by the customer representative. Document 860 may include elements highlighted based on the topic of the call. For example, if the topic of the call corresponds to a “billing” topic or to a “customer complaint” topic, the customer representative may be required to safeguard the call by authenticating the user. Document 860 may include highlighted elements that are important for safeguarding the call, such a safeguarding indicator element 862, a password element 864, an account pin element 866, a video account number element 868, and a profile candidate account number element 870. By highlighting the elements important for safeguarding the call, the customer representative may be able to efficiently authenticate the customer.

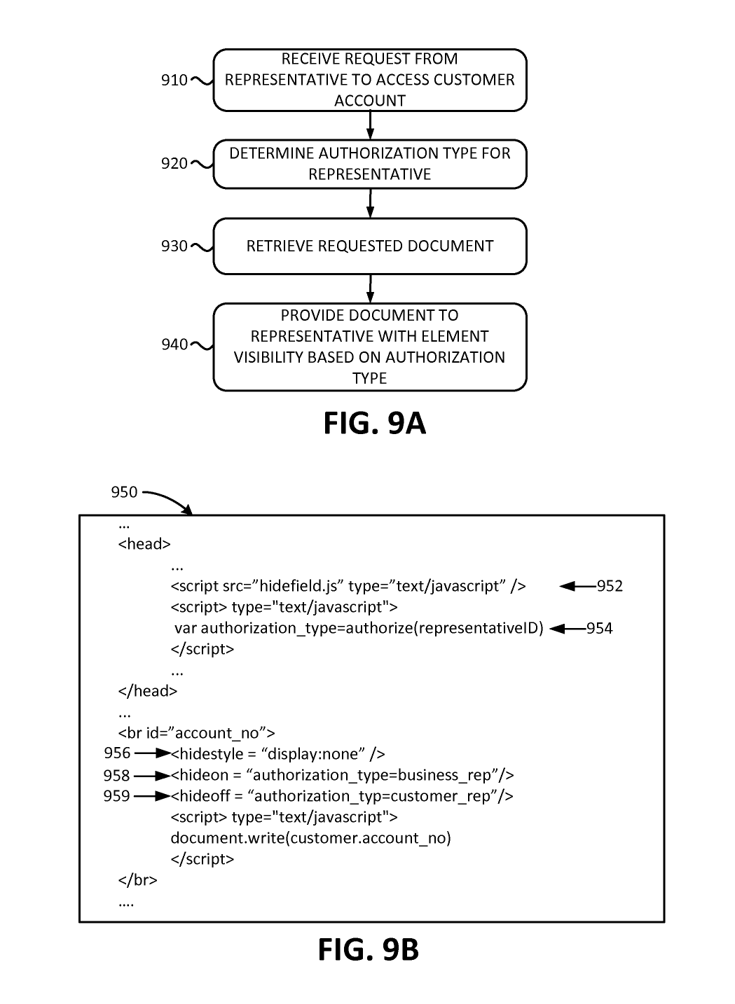

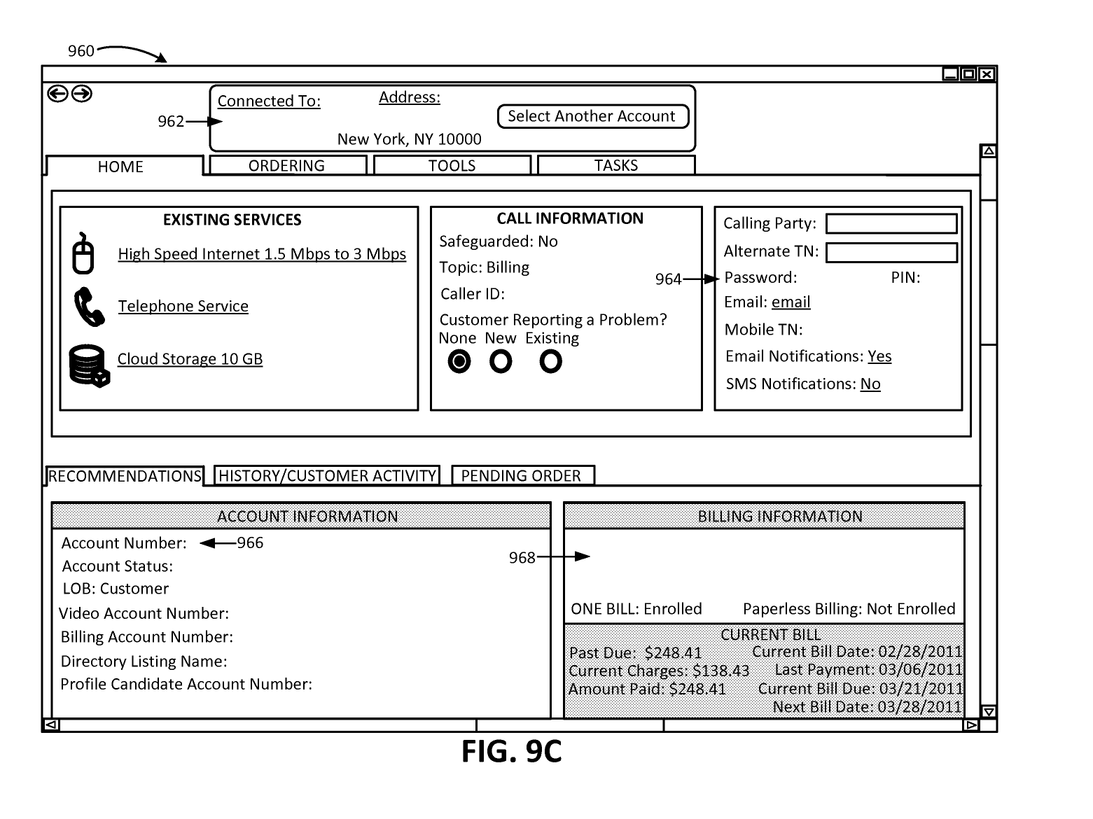

FIGS. 9A-9C are diagrams of a second example of generating and providing a document with context-dependent styling according to an implementation described herein. The example of FIGS. 9A-9C illustrates an example where particular fields of a document are visible or not visible based on an authorization type associated with a customer representative.

FIG. 9A illustrates a process for providing a document to a customer representative. A request may be received from a customer representative to access a customer account (block 910) and an authorization type may be determined for the customer representative (block 920). For example, the customer representative may log into document hosting system 130 and the authorization type of the customer representative may be determined by accessing an account associated with the customer representative. The customer representative may access a document that includes information about a particular customer's account. The requested document may be retrieved (block 930) and the document may be provided to the customer representative with element visibility based on the authorization type.

FIG. 9B illustrates a document portion 950 of the document provided to the customer representative. Document portion 950 may include a reference to a hidefield script 952 (which may correspond to styling expression processing script 410) and may include an authorization function 954 (which may correspond to context determining script 420). Authorization function 954 may determine an authorization type for the customer representative by accessing an account associated with the customer representative. Hidefield script 952 may process elements of the document to identify elements that include style activation terms, which, in this case, may correspond to the terms “hideon” and “hideoff.”

A document element with an identifier of “account_no” may include hidestyle expression 956, a hideon expression 958, and a hideoff expression 959. Hidestyle expression 956 may indicate that if hiding is activated for the element, the element will not be displayed. Hideon expression 958 may indicate that hiding will be activated if the authorization type corresponds to a business representative and hideoff expression 959 may indicate that hiding will not be activated if the authorization type corresponds to a customer representative. That is, a customer representative may be authorized to view an account number of a customer while a business representative may only be authorized to view statistics associated with a customer without being authorized to view any information identifying the customer.

Hidefield script 952 may process the document to identify elements that include a “hideon” or a “hideoff” term, may determine whether a condition associated with the “hideon” or “hideoff” term is satisfied, and may apply the style indicated by a “hidestyle” expression, if the condition associated with the “hideon” or “hideoff” term is satisfied.

FIG. 9C illustrates an example document 960 may include elements hidden based on the authorization type associated with the person accessing the document. Document 860 may be provided by document hosting system 130 to client device 110 operated by the customer representative when the customer representative is a business representative that is not authorized to view information identifying a customer. For example, document 860 may include a “connected to” element 962, a “password” element 964, an “account number” element 966, and a “billing information” set of elements 968, which may be hidden and therefore not displayed when the document is accessed by a business representative.

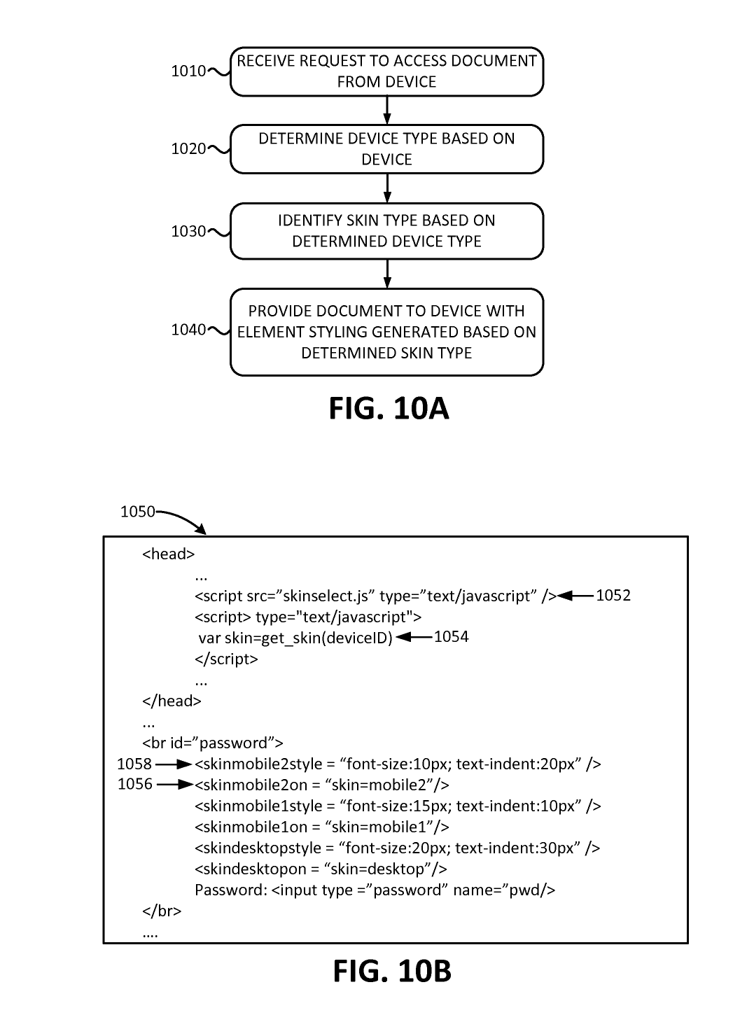

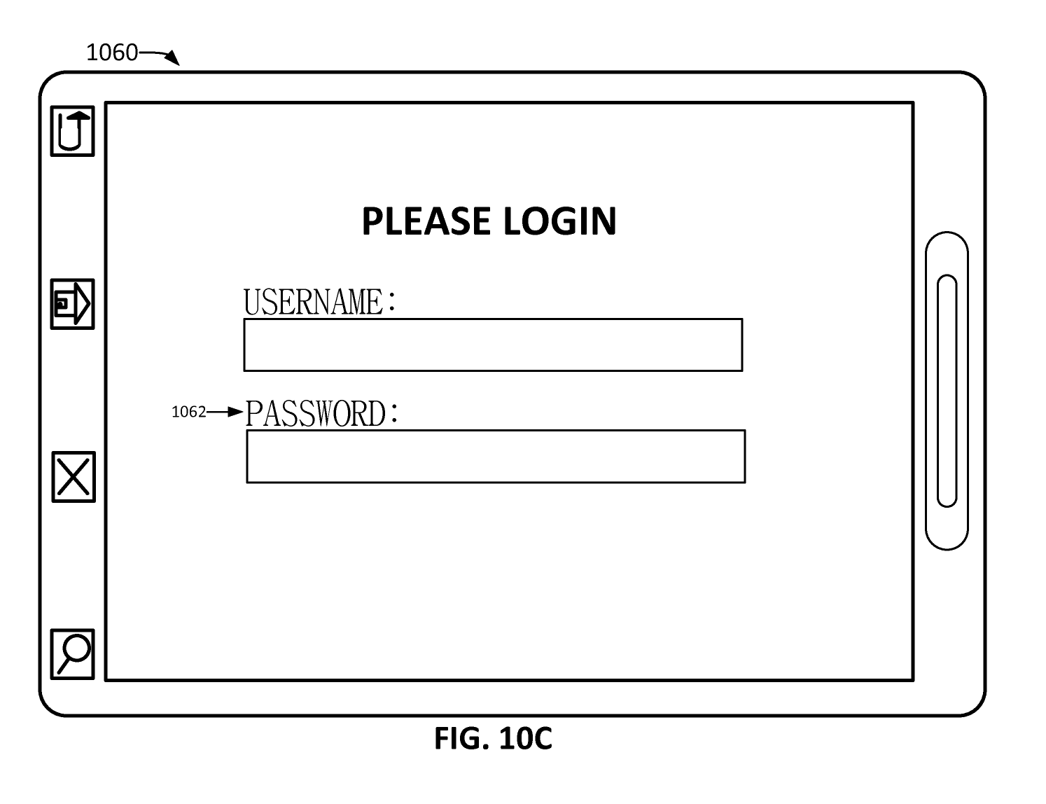

FIGS. 10A-10C are diagrams of a third example of generating and providing a document with context-dependent styling according to an implementation described herein. The example of FIGS. 10A-10C illustrates an example where styling for elements of a document is determined based on a type of device used to access the document. For example, different skins may be associated with different devices. Thus, if a user accesses the document with a mobile device, a mobile device skin may be applied to the document and the styling of elements in the document may be based on the mobile device skin. If, on the other hand, the user accesses the document with a desktop device, a desktop skin may be applied to the document and the styling of the elements in the document may be based on the desktop device skin.

FIG. 10A illustrated a process for providing a document to a device, where the styling of the document is based on a type associated with the device. A request to access a document may be received from a device (block 1010) and a device type may be determined based on the device (1020). For example, a user may access a document hosted by document hosting system 130 using a browser application running on a mobile device and styling expression processing script 410 may cause the browser application to determine that the device is a mobile device.

A skin type may be identified based on the determined device type (block 1030) and the document may be provided to the device with element styling generated based on the determined skin type (block 1040). For example, a “skin” variable may be assigned a value based on the determined device type and a style for an element may be selected based on the value assigned to the “skin” variable.

FIG. 10 B illustrates a document portion 1050 of the document provided to the mobile device. Document portion 1050 may include a reference to a skinselect script 1052 (which may correspond to styling expression processing script 410) and may include a get_skin function 1054 (which may correspond to context determining script 420). Get_skin function 1054 may determine a skin type based on a device identifier associated with a device that has accessed the document. Skinselect script 1052 may process elements of the document to identify elements that include style activation terms, which, in this case, may correspond to the terms of the form skin*on, where the “*” indicates different types of skin. Thus, the document may support multiple skins, such as “mobile2,” “mobile1,” and “desktop.” When a particular style activation term matches the value of the “skin” variable, a corresponding style definition term may be identified and a particular style may be applied based on style definition expression 438 that includes the corresponding style definition term. Thus, assuming the variable skin is assigned the value “mobile2,” skinselect script 1052 may identify skin activation term 1056 and skin definition term 1058 and may process skin definition term 1058 to apply the style to the document element with the “password” identifier.

FIG. 10C illustrates an example document 1060 that includes elements with a style based on a skin selected based on a device type. Thus, if skin definition term 1058 is selected by skinselect script 1052, the element “password,” may be displayed with a font size of 10 pixels and a text indent of 20 pixels.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while series of blocks have been described with respect to FIGS. 5, 6, 7, 8A, 9A, and 10A, the order of the blocks may be modified in other implementations. Further, non-dependent blocks may be performed in parallel.

As another example, while in the examples of FIGS. 8A-D, 9A-9C, and 10A-10C, the context specifications are illustrated as being obtained from a source external to the presented document, in another implementation, the context specifications may be obtained from input received in connection with the document. For example, the presented document may include an element that prompts the user to enter a particular piece of information, such as a prompt with text: “Enter a call topic.” The input received from the user may then be used to determine the context specifications. For example, if the user enters “billing” in response to a prompt to select a call topic, or if the user selects “billing” from a list of presented options, the fields relevant to a billing topic may be highlighted in response to the received input.

As yet another example, instead of highlighting a first set of elements, all elements in the document not included in the first set may be lowlighted (e.g., dimmed). Elements may be lowlighted by setting an opacity style attribute to a particular value if the context specifications are not met.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method performed by a computer device, the method comprising:
retrieving, by the computer device, a document;
determining, by the computer device, context information associated with the document;
identifying, by the computer device, an element in the document, where the element includes a context-dependent style specification;
determining, by the computer device, whether a context associated with the context-dependent style specification matches the determined context information; and
applying, by the computer device, a style associated with the context-dependent style specification to the element, when the context associated with the context-dependent style specification matches the determined context specification.

2. The method of claim 1, wherein the context-dependent style specification includes:
a style activation expression that specifies the context; and
a style definition expression that specifies the style.

3. The method of claim 1, wherein the determining the context information associated with the document includes:
running a context determining script included in the document to determine the context information.

4. The method of claim 1, wherein the document includes a styling expression processing script, and wherein running the styling expression processing script causes the computer device to perform the applying the style associated with the context-dependent style specification to the element, when the context associated with the context-dependent style specification matches the determined context specification.

5. The method of claim 1, wherein the applying the style associated with the context-dependent style specification to the element includes:
identifying the context-dependent style specification by identifying a style activation term associated with the element;
identifying a style definition expression associated with the context-dependent style specification;
parsing out one or more arguments of the style definition expression; and
executing a call to a library of style manipulation functions using the parsed out one or more arguments.

6. The method of claim 5, wherein the library of style manipulation functions includes a jQuery library.

7. The method of claim 1, wherein the element includes at least one of:
a Hypertext Markup Language element; or
an Extensible Markup Language element.

8. The method of claim 1, wherein the document is associated with a customer service call and wherein the context information includes a topic associated with the customer service call.

9. The method of claim 1, wherein the document is associated with a customer service call and wherein the context information includes an authorization type associated with a user accessing the document.

10. The method of claim 1, wherein the context information includes a device type associated with the computer device and wherein the style is based on a skin associated with the device type.

11. The method of claim 1, wherein the applying the style associated with the context-dependent style specification to the element includes:
highlighting the element.

12. The method of claim 1, wherein the applying the style associated with the context-dependent style specification to the element includes:
hiding the element.

13. The method of claim 1, wherein the applying the style associated with the context-dependent style specification to the element includes:
applying at least one of a particular font, text size, text color, background color, or text effect to the element.

14. A computer device comprising:
a memory to store instructions; and
a processor configured to execute the instructions to:
retrieve a document;
determine context information associated with the document;
identify an element in the document, where the element includes a context-dependent style specification;
determine whether a context associated with the context-dependent style specification matches the determined context information; and
apply a style associated with the context-dependent style specification to the element, when the context associated with the context-dependent style specification matches the determined context specification.

15. The computer device of claim 14, wherein the context-dependent style specification includes:
a style activation expression that specifies the context; and
a style definition expression that specifies the style.

16. The computer device of claim 14, wherein the document includes a styling expression processing script, wherein running the styling expression processing script causes the processor to be configured to apply the style associated with the context-dependent style specification to the element, when the context associated with the context-dependent style specification matches the determined context specification.

17. The computer device of claim 14, wherein, when the processor applies the style associated with the context-dependent style specification to the element, the processor is configured to:
identify the context-dependent style specification by identifying a style activation term associated with the element;
identify a style definition expression associated with the context-dependent style specification;
parse out one or more arguments of the style definition expression; and
execute a call to a library of style manipulation functions using the parsed out one or more arguments.

18. A non-transitory computer-readable medium storing instructions executable by one or more processors, the non-transitory computer-readable medium comprising:
one or more instructions to retrieve a document;
one or more instructions to determine context information associated with the document;
one or more instructions to identify an element in the document, where the element includes a context-dependent style specification;
one or more instructions to determine whether a context associated with the context-dependent style specification matches the determined context information; and
one or more instructions to apply a style associated with the context-dependent style specification to the element, when the context associated with the context-dependent style specification matches the determined context specification.

19. The non-transitory computer-readable medium of claim 18, wherein the context information includes one or more of:
a topic associated with a customer service call,
an authorization type associated with a user accessing the document, or
a device type associated with the computer device.

20. The non-transitory computer-readable medium of claim 18, wherein the one or more instructions to apply the style associated with the context-dependent style specification to the element include:
one or more instructions to highlight the element, hide the element, or apply at least one of a particular font, text size, text color, background color, or text effect to the element.
